(19) United States
(12) Patent Application Publication
(10) Pub. No.: US 2026/0140357 A1
(43) Pub. Date: May 21, 2026

(54) EYE TRACKING

(71) Applicant: Carl Zeiss Microscopy GmbH, Jena (DE)

(72) Inventor: David Dobbelstein, Oberkochen (DE)

(73) Assignee: Carl Zeiss Microscopy GmbH, Jena (DE)

(21) Appl. No.: 19/382,781

(22) Filed: Nov. 7, 2025

(30) Foreign Application Priority Data
Nov. 19, 2024 (DE) 10 2024 133 935.7

(51) Int. Cl. G02B 21/24; G02B 21/02; G06F 3/01

(52) U.S. Cl. CPC G02B 21/245; G02B 21/025; G06F 3/013

(57) ABSTRACT

A module for a microscope for determining a fixation point of a user and for controlling a function of the microscope is provided, comprising an input interface for receiving sensor data from an eye tracking sensor with information relating to the fixation point of the user and for receiving operating data for operating the function of the microscope; an analysis unit for determining the fixation point of the user based on the sensor data and for determining a control command for controlling the function of the microscope based on the operating data and/or the fixation point; and an output interface for transmitting the control command to a control unit of the microscope to control at least one function of the microscope.

### CROSS REFERENCE TO RELATED APPLICATION

This application claims priority to German patent application 10 2024 133 935.7 filed on Nov. 19, 2024, which is hereby incorporated by reference in its entirety.

### TECHNICAL FIELD

The present disclosure relates to a module for a microscope for determining a fixation point of a user and for controlling a microscope function. The present disclosure further relates to a corresponding system as well as a microscope. The present disclosure furthermore relates to a method for operating a microscope as well as the use of a module with a microscope.

### BACKGROUND

An operation of a microscope when looking through one or two eyepieces can be challenging for a user. Microscopes can have operating elements for setting different microscope functions, such as, for example, a focus, a zoom or a movement of the sample underneath the lens. However, the user may not be able to see said operating elements when he/she looks through the eyepiece or the eyepieces, respectively, of the microscope to observe a sample. The user may have to identify the operating element by touching or may have to operate the operating elements blindly, respectively, and check the effects of the operation when looking through the eyepieces.

Microscopes can be controlled via rotary knobs, which can be reached easily and which can be operated without direct view of the operating element. For example, a focus and/or a zoom level, thus a magnification of the microscope, can be set using said rotary knobs. However, a movement of the sample or of the preparation, respectively, is occasionally not possible with such rotary knobs. In other words, a navigation, e.g. a visual navigation on the sample, can be limited to only one degree of freedom, namely the magnification.

In the case of a complete 3D navigation, the navigation with three degrees of freedom, in the case of which a lateral movement of the sample is to be carried out as well, the control or operation, respectively, of the microscope can become more complicated.

For lateral sample movements a motorized table, optionally a so-called XY table, can be provided, wherein the sample can be moved under the microscope. The control of a table of this type can require an additional user input and sensitivity.

In the case of current devices, for example from Zeiss, a user input of this type can be made using a joystick and/or a touchscreen. However, the user input can have a high complexity. The user may change between two alternating modes on the joystick for the 3D navigation, wherein either a zoom level or a sample movement can take place here.

This may pose a risk for operating errors and frustration resulting therefrom for a user. For example, forgetting the module switch-over can occur, so that the user performs a sample movement instead of zooming and vice versa.

A navigation on the can be challenging and difficult in the case of embodiments of this type.

EP 1 131 663 B1 describes a microscope which is equipped with an eye tracking sensor, wherein the user can control different functions of the microscope with his/her line of sight. The user can activate a function by looking at different icons. The user controls the microscope exclusively with his/her eyes. The user needs to know exactly which icon he/she has to look at or activate, respectively, for which function. The system is not intuitive because the user has to initially observe the icons in order to understand the icons. This can result in an unintentional activation of functions. The system only provides for the operation of a single function, which is initially activated in a complex manner by looking at an icon, thus not the sample. The navigation on the sample is made more difficult hereby because the user has to inevitably glance away from the sample in order to activate a function.

There is thus a need for providing for an improved operability of a microscope. This need increases with additional functions, which can be integrated into modern microscopes.

### SUMMARY

A module for a microscope for determining a fixation point of a user and for controlling a function of the microscope is provided, comprising an input interface for receiving sensor data from an eye tracking sensor with information relating to the fixation point of the user and for receiving operating data for operating the function of the microscope; an analysis unit for determining the fixation point of the user based on the sensor data and for determining a control command for controlling the function of the microscope based on the operating data and/or the fixation point; and an output interface for transmitting the control command to a control unit of the microscope to control at least one function of the microscope.

A method for operating a microscope is provided, wherein the method comprises receiving sensor data from an eye tracking sensor with information relating to a fixation point of a user; receiving operating data for controlling at least one function of the microscope based on an operating input from the user on an operating unit; determining a position of the fixation point of the user based on the sensor data; determining a control command for controlling the at least one function of the microscope based on the operating data and the fixation point; and transmitting the control command to a control unit of the microscope to control the at least one function of the microscope.

### BRIEF DESCRIPTION OF THE DRAWINGS

The disclosure is described and explained in more detail below on the basis of a few selected exemplary embodiments in connection with the enclosed drawings, in which:

FIG. 1 shows a schematic illustration of a system comprising a microscope and an eye tracking sensor for determining the fixation point;

FIG. 2 shows a schematic illustration of a module according to the disclosure in a system for operating a microscope;

FIG. 3a+3b each show a schematic image section for clarifying a function of a microscope;

FIG. 4a+4b show, analogously to FIGS. 3a and 3b, a schematic illustration of a further function of a microscope;

FIG. 5 shows a schematic illustration of a microscope with a system according to the disclosure; and

FIG. 6 schematically shows the steps of a method according to the disclosure.

### DETAILED DESCRIPTION

The present disclosure may solve the object of specifying an improved option for controlling a microscope. A sample navigation can be improved, wherein, optionally, a gaze of a user does not need to deviate from the sample for this purpose. Optionally, an option can be created for operating a microscope without hands, so that the user's hands are free to work on the sample.

A module for a microscope for determining a fixation point of a user and for controlling at least one microscope function may be provided, comprising an input interface for receiving sensor data from an eye tracking sensor with information relating to a fixation point of a user and for receiving operating data for controlling at least one function of the microscope; an analysis unit for determining a position of the fixation point of the user based on the sensor data and for determining a control command for controlling the at least one function of the microscope based on the operating data; and an output interface for transmitting the control command to a control unit of the microscope in order to control at least one function of the microscope, thus to operate the microscope based on the operating data and the fixation point.

A system for determining a fixation point of a user and for controlling a microscope function may be provided, comprising a module as described herein; an eye tracking sensor for generating sensor data with information relating to a fixation point, thus in particular relating to a line of sight and/or a focus of a user; and an operating unit for generating operating data based on an operating input from the user for controlling at least one function of the microscope.

A microscope with a system as described herein and at least one control unit may be provided, which controls a function of the microscope based on a control command of the analysis unit of the module.

A method for operating a microscope with the following steps may be provided: receiving sensor data from an eye tracking sensor with information relating to a fixation point of a user; receiving operating data for controlling at least one function of the microscope based on an operating input from a user on an operating unit; determining a position of the fixation point of the user based on the sensor data; determining a control command for controlling the function of the microscope based on the operating data and the fixation point; and transmitting the control command to a control unit of the microscope in order to control at least one function of the microscope.

The disclosure may relate to a use of a module as described herein with a microscope, to control at least one microscope function of the microscope.

All the features described herein are not limited to being used in the respective specified combination but can also be used in other combinations or alone, within the scope of the present disclosure.

Fixation point, focal point or point of interest (POI) of a user can be defined as a point or a region or an area on a sample, which the user looks at. This focal point can be available at any time. The focal point on the sample can be determined from the sensor data from an eye tracking sensor and optionally further microscope-specific data. The fixation point can additionally be subject to a weighting, during which the dwell time of the gaze on a region or an area on the sample is captured. Starting at a threshold value for a dwell time of the gaze on this point, this region, or this area, a fixation point of increased interest can optionally be recognized. The fixation point can be determined based on a line of sight and a focus of the user. The fixation point can be determined using so-called eye tracking, thus tracking the movement of the eye(s) of the user. It can be captured based on a known microscope geometry as well as on the basis of an eye position of the user, which region on the sample is observed by the user.

A microscope function can include all setting and operating options of a microscope, such as, for example, a zoom, thus a magnification level, a focusing, a movement of the sample, a setting of a lighting, a placing of an optical filter, for example of a polarization filter, turn-on and turn-off of an additional lighting, optionally of a wavelength-dependent additional lighting. A staining of a sample can be understood as a microscope function. Memory functions of a sample image or the like can additionally be understood as functions.

By providing a module for a microscope for determining a fixation point of a user and for controlling a microscope function, a retrofit solution may be provided. An improved operability can be created hereby for an already existing microscope. The module may only have the components technically necessary, e.g., an input interface, an output interface as well as an analysis unit. A cost-optimized and installation space-optimized module, which can be installed easily and which contributes to the improvement of the operability, optionally of an intuitive operability of the microscope, can be created. A variable module can be created by using the reception of sensor data from an eye tracking sensor with information relating to a fixation point of a user as well as by using the reception of operating data for controlling at least one function of the microscope. The operating data can be made by means of an input device or an operating unit, respectively, of the microscope. The module can be combined with a plurality of eye tracking sensors as well as a plurality of operating units. An eye tracking sensor can be formed for directly determining a fixation point. An eye tracking sensor can be configured to generate raw sensor data, wherein a determination of the fixation point from the raw sensor data is carried out in another unit, for example a PC connected to the microscope.

An advantageous control of the microscope can take place technically easily as well as efficiently, quickly and intuitively using an analysis unit which determines a control command for controlling the function of the microscope based on the fixation point as well as the operating data. The fixation point can be determined consistently, thus continuously, wherein the fixation point at the time of this input is used for generating a control command when capturing an operating input.

An output interface for transmitting the control command to a control unit of the microscope can provide for a highly flexible module, which can be combined with a plurality of control units of the microscope.

The input and the output interface may be implemented as two separated interfaces, or may be provided as one input/output interface. The interface(s) can be formed in a wired as well as wireless manner, wherein any standard or also a proprietary communication can be used for this purpose.

Optionally, an improved retrofit solution, optionally a retrofit solution of a desired operating function of a microscope, can be created using a system with a module as described herein as well as an eye tracking sensor and an operating unit. Optionally, customer requirements can be addressed individually hereby to obtain, for example, a customized solution for improving the operability of a desired function.

The eye tracking sensor can be pushed, for example, over the eyepiece to capture the eye position of a user. Optionally, a comprehensive retrofit solution, which can be attached quickly, can thus be created.

Optionally, a microscope equipped with a system of this type can offer the opportunity to deliver a microscope with an advantageous control and improved operability to a customer directly upon delivery. Optionally, in the case of a direct combination of microscope and system, the system can be integrated into the microscope in an advantageous manner.

The analysis unit of the module can be formed, for example, as part of a control unit already installed in the microscope, wherein, optionally, the system can resort to already existing communication infrastructure of the individual modules of the microscope. The analysis unit can also be formed as part of a PC which is connected to the microscope.

In an optional implementation, the input interface is formed for receiving operating data from a joystick, a touchpad, a foot pedal and/or a microphone, thus operating data in the form of a voice command. The microscope can be operated using intuitive and (optionally known) input devices and methods. A direction can be specified intuitively by the line of sight of the user, the fixation point can thus be set, and a control or operation, respectively, of the microscope can additionally take place using (optionally known) input devices. Rotary knobs as well as operating buttons can be used as input devices for a zoom and/or a focus.

Optionally, the output interface is configured for transmitting the control command to a control unit of an XY table for controlling a sample carrier using the XY table based on an operating input as well as on a fixation point. Optionally, the control command can cause hereby that the sample is shifted by simply looking at the sample and making an operating input. After the shifting process, the sample may be centered with respect to the fixation point at the time of the operating input. A surrounding area around the fixation point can thereby likewise be observed. A speed of the shifting of the sample can be determined at the time of the operating input, for example using the distance between the center and the fixation point. Optionally when the fixation point lies on an edge of the section of the sample, a quicker shifting of the sample can take place so that an efficiency of the work can be increased. To control the function, the gaze can remain on the sample, which may simplify a navigation on the sample. A control command, which may cause a triggering of a microscope function, can already be generated when recognizing an operating input. Optionally, an intensity and/or direction of the operating input can be recognized and an intensity, severity, height, speed, etc., of the microscope function to be controlled may be controlled as a function of the recognized intensity and/or of the recognized direction of the operating input.

In a further optional implementation, the output interface can be configured or formed for transmitting the control command to a control unit of a zoom of the microscope for controlling a zoom of the microscope based on an operating input as well as a fixation point. A zooming, thus a magnifying of the observed section, can take place intuitively using a guided line of sight using this design. Optionally, a sample navigation is simplified so that a user can quickly observe the section in the desired size.

Optionally, the analysis unit is formed for determining a corresponding control command.

In a further optional implementation, the analysis unit is formed for generating a control command for a focusing unit of a microscope, which affects an automatic focusing on the fixation point. A sample navigation and sample observation can be simplified hereby, in particular in the case of three-dimensional samples. A complex adjusting of the focus is not necessary because the analysis unit can determine, based on the fixation point, preferably in an iterative process, in which plane the fixation point lies, and then generates a control command, which focusses the microscope at said plane. For example, an area around the fixation point can be used for the automatic focus in order to specifically focus on this area. A so-called focusing can be triggered, which then only considers this area in its focus optimization.

In a further optional implementation, the analysis unit can be formed for synchronizing the control command for controlling the control unit of an XY table and the control command for controlling the zoom as well as preferably the control command for a focusing unit to improve a sample navigation. Optionally, it can be attained using the synchronization of the above-mentioned control commands that the sample is centered and that zooming into the sample takes place at the same time. A navigation takes place on the sample, which can be captured intuitively and which can be carried out quickly. This may provide for an efficient working with the microscope because an efficient control of three degrees of freedom, thus a moving of the sample and of a zoom is known, for example from a touch navigation by means of digital maps. The present disclosure may provide for a similarly efficient control of three degrees of freedom under the microscope in an advantageous manner. It is conceivable that a movement speed of the sample or of the image of the sample, respectively, can (always) be the same, independently of the zoom level to optionally further improve an operability and sample navigation. The movement speed of the XY table can be a function of the zoom level so that a speed of the sample movement takes place quasi independently of the zoom level in a user perception.

In an optional implementation, the analysis unit can be formed for determining a user based on the sensor data and for loading a predetermined user profile for the microscope based on the determined user. Optionally, an efficiency and operability of the microscope can be further improved and accelerated hereby. For example, a presetting of the microscope, such as a pupil distance of the user, can be stored in the loaded profile. Optionally, the microscope can be automatically set to the correct pupil distance. Other user-specific data, such as a preferred zoom level at the beginning of the sample observation, a lighting intensity, a contrast or the like can be stored. It is conceivable to authorize a user so that only an authorized user can observe the sample.

According to the disclosure a simultaneous navigation, optionally with respect to three axes, thus zoom and movement of the sample, as well as the field of view of the microscope, can be possible as an efficient interaction when looking through the eyepieces.

The above-mentioned module, optionally the eye tracking sensor of the module, can be integrated directly into the eyepieces or can be realized as an additional module, for example for placing onto the eyepieces.

The XY table or cross table can be understood to be a device configured to move objects in two dimensions within a plane, and to position them accurately. An XY table can consist of or include two guide systems working linearly, which are optionally arranged at a right angle to one another. Optionally, through the combination of the movements of both guide systems, the object can be positioned at any desired point within the work area.

Eye tracking, also gaze detection or oculography, can refer to the recording of the gaze movements of a person, which can consist mainly of or include fixations, saccades, thus quick eye movements, and regressions.

Devices and systems, which perform a recording or image capturing and which provide for an analysis of the gaze movements, can be referred to as eye trackers or eye tracking sensors. An eye tracking sensor or gaze tracking sensor can be configured to record and optionally analyze the eye movements of a person. This makes it possible to record what a person is looking at and, optionally, how long the person is focusing on a particular point. This data can be used for analyzing visual perceptions, attentions and cognitive processes.

A method according to the disclosure can include the following steps or a device for carrying out the method can be configured to carry out the following steps: recognizing an operating input; tapping the focal point at the time of registering the operating input; calculating a necessary XY table movement to center the sample with respect to the focal point; executing a control command and effecting a table centering of the XY table; and/or recognizing an operating input; tapping the focal point at the time of the operating input; determining a region or an image section, respectively, around the focal point; and using the image section for a focusing.

For carrying out the method, the device can have a specific characteristic, optionally on the module side, as follows: an eye tracking module as well as at least one input modality for a control command of a controllable XY table and/or of a controllable zoom.

Alternatively, or additionally, an eye tracking module can be combined with a second input modality for the control command of a controllable focus.

A history of the focal points can be recorded continuously over time, optionally in the case of operating inputs, in the case of which the input process requires a period of time, such as, for example, in the case of voice commands. The focal point at the beginning of the operating input, thus, for example, the voice command, can be subsequently used for generating the control command.

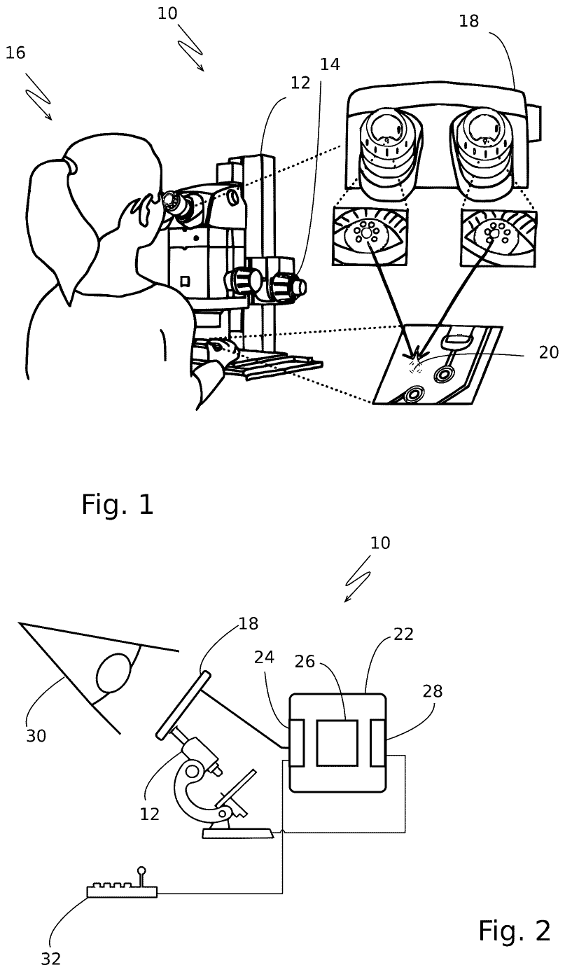

In FIG. 1 a system 10 is shown in simplified illustration comprising a microscope 12 with operating elements 14 as well as an eye tracking sensor 18, which measures the eye movements of a user 16.

In the example implementation, an analysis unit is integrated into the eye tracking sensor 18 in order to determine a fixation point 20 based on the eye position of the user 16.

The operating elements 14 of the microscope 12 are illustrated as rotary knobs. Different operating elements 14 can also be used. The selected representation serves to better understand the disclosure.

It is in particular conceivable that the operating elements 14 can be operated by hand as well as electrically, wherein an electric actuator effects a rotation of the operating elements 14 and the functions, such as, for example, a focusing and/or zoom function, thus magnification function, is performed in this way.

The system 10 thus makes it possible to capture a fixation point 20 of the user 16 and to control at least one operating function, for example a zoom function of the microscope 12, based on the fixation point 20.

A further system 10 is shown schematically in simplified illustration in FIG. 2.

The system 10 comprises a module 22 for a microscope 12 for determining a fixation point of a user for controlling at least one function of the microscope 12.

The selected illustration for the microscope 12 is only of an exemplary nature.

The module 22 comprises an input interface 24, an analysis unit 26 and an output interface 28.

The input interface 24 is formed for receiving sensor data from an eye tracking sensor 18 with information relating to a fixation point, thus in particular a line of sight and/or a focus of a user. The input interface 24 is additionally formed for receiving operating data from at least one operating unit 32.

The operating data as well as the sensor data are processed by the analysis unit 26, wherein the analysis unit 26 determines the position of the fixation point on the sample and/or an image of the sample from the sensor data.

The analysis unit 26 further determines a control command for controlling at least one function of the microscope 12 based on the fixation point as well as the operating input or the operating data, respectively, which are generated by means of the operating unit 32.

The output interface 28 is formed for transmitting the control command determined by the analysis unit 26 to the microscope 12, for example to a control unit of the microscope 12.

To clarify the setup, an eye 30 of the user is illustrated in a schematically simplified manner.

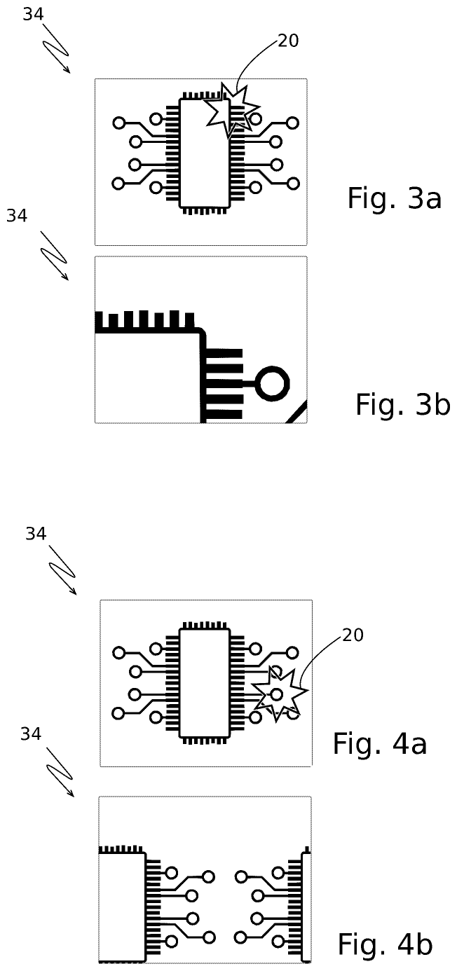

An image section 34 of a sample is illustrated in a simplified manner in FIGS. 3a and 3b to clarify the mode of action of the disclosure.

In FIG. 3a, the sample comprises a circuit. The latter is illustrated in a low zoom level, wherein a fixation point 20 is located at the upper image edge so as to be offset slightly right to the center.

If a user selects the function of zooming by means of an operating unit, the analysis unit of the module calculates the position of the fixation point 20 on the image and generates a control command to zoom into the area marked by the fixation point by means of the microscope.

An example result of this operating process is illustrated in a simplified manner in FIG. 3b.

The mode of action of a further function is illustrated analogously in FIGS. 4a and 4b.

In contrast to FIGS. 3a and 3b, no zoom, but a moving of the sample is illustrated in FIGS. 4a and 4b.

The moving can be carried out, for example, by means of an XY table, on which a sample carrier is arranged. A control command can be executed thereby, which effects a moving of the sample in two dimensions, thus in X direction and/or in Y direction.

The initial situation is illustrated in FIG. 3a, wherein a fixation point 20 was recognized on the right image edge.

If a user requests by means of a corresponding operating input that the sample is moved, the analysis unit determines a control command, which effects that the sample is moved by means of the XY table in such a way that the area of the sample determined by the fixation point 20 is located in a centered manner, centrally, in the image section after moving the sample.

For the sake of clarity, the fixation point 20 is no longer illustrated in FIGS. 3b and 4b.

It can be understood that in an example design, a shifting of the sample as well as a zooming into the sample can take place in a synchronized manner. A user can request via operating input hereby that the sample is centered about the fixation point on the one hand and that zooming into the fixation point takes place on the other hand.

A speed of the sample movement according to the selected zoom level can advantageously be adapted hereby, so that the sample always moves at the same speed under the microscope for the observer.

In other words, this means that a low movement speed is carried out by means of the XY table for a high zoom level and vice versa.

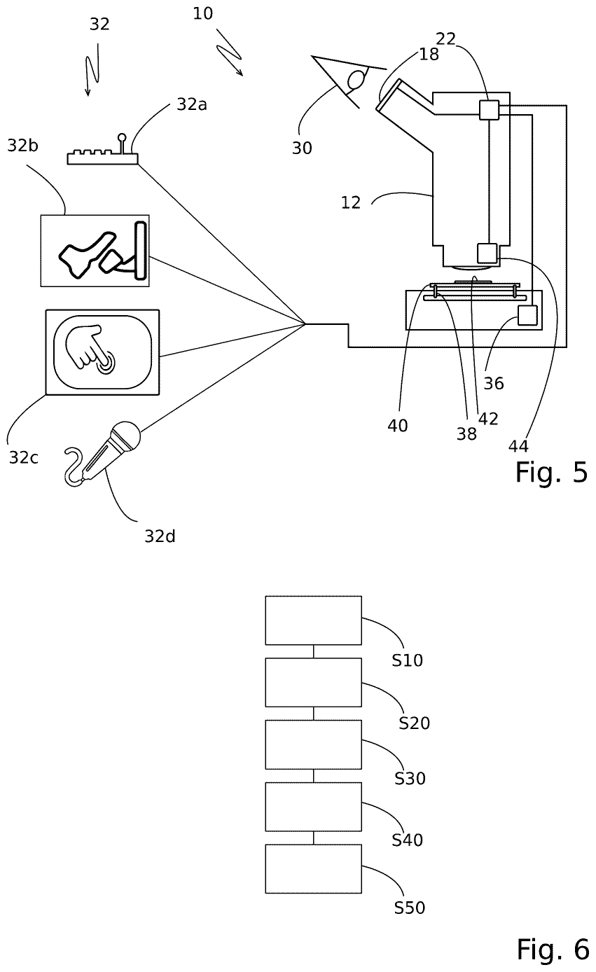

A system 10 is illustrated in more detail in FIG. 5.

The system 10 comprises a microscope 12, on which an eye tracking sensor 18 as well as a module 22 are arranged.

An input interface of the module 22 is connected to one or several operating units 32, wherein the operating units 32 can be formed as joystick with keypad 32a, as foot pedal 32b, as touchpad 32c and/or as microphone 32d for operating via voice command.

The module 22 is further connected to a control unit 36 for controlling an XY table 38, wherein a sample carrier 40, on which a sample 42 is arranged, is connected to the XY table 38.

The microscope 12 additionally comprises a control unit 44 for controlling a zoom function and preferably autofocus function, wherein the control unit 44 is likewise connected to the module 22.

An operating unit in the form of a foot pedal 32b or in the form of a microphone 32d offers the advantage that the hands of a user remain free when operating the microscope 12, so that a manual manipulation can also be carried out on the sample 42 parallel to operating the microscope 12.

The sample 42 can be worked on by observing the sample 42 by means of the microscope 12.

An operating unit 32 in the form of a joystick with keypad 32a or in the form of a touchpad 32c offers the advantage that the operation can take place highly intuitively because a user often uses operating units 32 of this type in everyday life.

The steps of a method according to the disclosure are illustrated schematically in FIG. 6.

Receiving of sensor data from an eye tracking sensor with information relating to a fixation point of a user takes place in a first step S10.

Operating data for operating at least one function of the microscope based on an operating input from a user on an operating unit is received in a second step S20.

Determining a position of the fixation point of the user based on the sensor data takes place in a third step S30.

A control command for controlling the function of the microscope based on the operating data and the fixation point is determined in a fourth step S40.

Lastly, the control command is transmitted to a control unit of the microscope in a fifth step S50 in order to control at least one function of the microscope.

The disclosure was described and explained comprehensively based on the drawings and the description. The description and explanation are to be understood as example and not in a limiting manner. The disclosure is not limited to the disclosed implementations. Other implementations or variations follow for the person of skill in the art when using the present disclosure as well as during an exact analysis of the drawings, of the disclosure and of the following patent claims.

The words “comprising” and “with” in the patent claims do not rule out the presence of further elements or steps. The indefinite article a or an does not rule out the presence of a plurality. An individual element or an individual unit can carry out the functions of several of the units mentioned in the patent claims. An element, a unit, an interface, a device and a system can partly or completely be implemented in hardware and/or software. The pure naming of some measures in several different dependent patent claims is to not be understood to the effect that a combination of these measures cannot likewise be used in an advantageous manner. Reference symbols in the patent claims are not to be understood in a limiting manner.

### REFERENCE SYMBOLS

10 system
12 microscope
14 operating element
16 user
18 eye tracking sensor
20 fixation point
22 module
24 input interface
26 analysis unit
28 output interface
30 eye
32 operating unit
32a joystick with keypad
32b foot pedal
32c touchpad
32d microphone
34 image section
36 control unit for XY table
38 XY table
40 sample carrier
42 sample
44 control unit for zoom function and/or autofocus function
S10 to S50 steps of a method according to the disclosure

What is claimed is:

1. A module for a microscope for determining a fixation point of a user and for controlling a function of the microscope, comprising:
an input interface for receiving sensor data from an eye tracking sensor with information relating to the fixation point of the user and for receiving operating data for operating the function of the microscope;
an analysis unit for determining the fixation point of the user based on the sensor data and for determining a control command for controlling the function of the microscope based on the operating data and/or the fixation point; and
an output interface for transmitting the control command to a control unit of the microscope to control at least one function of the microscope.

2. The module according to claim 1, wherein the input interface is configured to receive operating data from at least one of: a joystick, a touchpad, a foot pedal, and a microphone.

3. The module according to claim 1, wherein the output interface is configured to transmit the control command to the control unit of an XY table to control a sample carrier of the microscope using the XY table based on an operating input and on the fixation point.

4. The module according to claim 1, wherein the output interface is configured to transmit the control command to the control unit of a zoom of the microscope to control the zoom of the microscope based on an operating input and the fixation point.

5. The module according to claim 1, wherein the analysis unit is configured to generate the control command for a focusing unit of the microscope, which is configured to cause an automatic focusing on the fixation point.

6. The module according to one claim 3, wherein the analysis unit is configured to synchronize the control command for controlling the control unit of the XY table and a control command for controlling a zoom of the microscope.

7. The module according to claim 3, wherein the analysis unit is configured to synchronize the control command for controlling the control unit of the XY table and a control command for controlling a zoom of the microscope and a control command for a focusing unit.

8. The module according to claim 1, wherein the analysis unit is configured to determine a user based on the sensor data and to load a predetermined user profile for the microscope based on the determined user.

9. A system for determining a fixation point of a user and for controlling a function of a microscope, comprising:
the module according to claim 1;
the eye tracking sensor for generating the sensor data with the information relating to the fixation point of the user, and
an operating unit for generating the operating data based on an operating input from the user.

10. A microscope, comprising a system according to claim 9 and a control unit configured to control the function of the microscope based on the control command of the analysis unit of the module.

11. A method for operating a microscope, comprising:
receiving sensor data from an eye tracking sensor with information relating to a fixation point of a user;
receiving operating data for controlling at least one function of the microscope based on an operating input from the user on an operating unit;
determining a position of the fixation point of the user based on the sensor data;
determining a control command for controlling the at least one function of the microscope based on the operating data and the fixation point; and
transmitting the control command to a control unit of the microscope to control the at least one function of the microscope.
